(19) United States
(12) Patent Application Publication
(10) Pub. No.: US 2005/0069776 A1
(43) Pub. Date: Mar. 31, 2005

(54) Method of producing a rechargeable electrochemical element , and an element made therefrom

(75) Inventors: Konrad Holl, Aalen-Dewangen (DE); Arno Perner, Ellwangen (DE); Horst Wagner, Rosenberg (DE); Kemal Akca, Ellwangen (DE); Rolf Hennrich, Ellwangen (DE); Alfons Joas, Tannhausen (DE); Dejan Ilic, Ellwangen (DE)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Varta Microbattery GmbH

(21) Appl. No.: 10/944,056

(22) Filed: Sep. 17, 2004

(30) Foreign Application Priority Data
Sep. 19, 2003 (DE) 103 45 348.2

(51) Int. Cl. H01M 4/40; H01M 10/44; H01M 4/04

(52) U.S. Cl. 429/231.95; 29/623.1; 205/59

(57) ABSTRACT

A method of producing a rechargeable electrochemical element comprising introducing a negative electrode composed mainly of indium, an uncharged positive electrode having an active compound containing lithium, and an electrolyte into a housing; and applying a charge to form a negative lithium/indium electrode in the element.

### CROSS REFERENCE TO RELATED APPLICATION

This application claims priority of German Application No. 10345348.2 filed Sep. 19, 2003.

### FIELD OF THE INVENTION

This invention relates to a method of producing a rechargeable electrochemical element having a negative electrode composed of a lithium/indium alloy, and having a positive, lithium-intercalating electrode in a housing, as well as an electrochemical element made from the method.

### BACKGROUND

Rechargeable electrochemical elements with lithium as the negative electrode material are known. The negative electrode in elements such as these is often composed of lithium/aluminium alloys or lithium/indium alloys.

By way of example, DE 38 16 199 A1 describes how a negative electrode is in the form of a two-layer electrode and is composed of a layer of a lithium/aluminium alloy and a layer of aluminium. A so-called “LiMOₓ” material is used as the positive electrode, normally in oxide form. In that case, M may normally be Co, Ni, Mn, possibly doped, for example, with Al, Ti, Mg, Zn, Cr, etc. The lithium alloys which are used as the negative active material are produced in a complex manufacturing process, for example, by high-temperature synthesis in an inert gas atmosphere, and under pressure. This synthesis is highly time-consuming and costly.

It would therefore be advantageous to provide a method of producing an electrochemical element having a negative electrode composed of a lithium/indium alloy, and having a positive, lithium-intercalating electrode, that can be made in a simple way.

### SUMMARY OF THE INVENTION

This invention relates to a method of producing a rechargeable electrochemical element comprising introducing a negative electrode composed mainly of indium, an uncharged positive electrode having an active compound containing lithium, and an electrolyte into a housing; and applying a charge to form a negative lithium/indium electrode in the element.

In another aspect, the invention relates to a method of producing a rechargeable electrochemical element comprising introducing a negative electrode composed mainly of indium, an uncharged positive electrode having an active compound containing lithium, and an electrolyte into a housing; and causing lithium in the positive electrode to migrate to the negative by applying a charge to form a negative lithium/indium electrode.

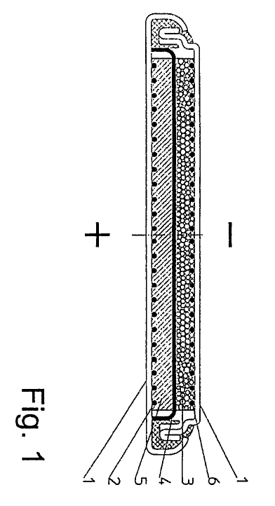

### BRIEF DESCRIPTION OF FIG. 1

FIG. 1 is a sectional view of an element in accordance with aspects of the invention.

### DETAILED DESCRIPTION

It will be appreciated that the following description is intended to refer to specific aspects of the invention selected for illustration in the drawing and is not intended to define or limit the invention, other than in the appended claims.

Since the materials used in the positive electrode, that is to say LiMOₓ, where M=Co, Ni, Mn, possibly doped, for example, with Al, Ti, Mg, Zn, Cr and the like are uncharged, the lithium ions migrate from the positive electrode to the negative indium electrode during the formation process or during the first charging step. The lithium is deposited there and forms a lithium/indium alloy. In particular, this may be a lithium/indium coating. By way of example, this process can be described as follows:
LiMOₓ+In_{y} [symbol] Li_{1-z}MOₓ+Li_{z}In_{y}

This process is highly reversible and has a high energy density.

The system may be used in cells with organic liquid electrolytes, such as lithium button cells, lithium round cells, and lithium wound cells. It may likewise be used in cells with a solid or polymer electrolyte, such as lithium polymer batteries.

These and further features are evident not only from the appended claims, but also from the description and FIG. 1, in which case individual features can each be implemented in their own right or in conjunction with one another in the form of sub-combinations for one aspect of the invention, and in other fields, and may represent advantageous embodiments as well as embodiments that are patentable in their own right. Division of the application into individual sections as well as intermediate headings does not restrict the general applicability of the statements made therein.

Selected aspects of the invention will be explained in more detail in the following text, in particular using the example of the production of a rechargeable element in the form of a button cell, which is illustrated schematically in FIG. 1.

An uncharged positive electrode 5 with an output conductor mesh 2 composed of a metal such as stainless steel or aluminium, which contains a material with a lithium phase as the active material, or a material in which lithium is incorporated, is introduced into the cell housing 1. This material is, for example, LiMOₓ, where M=Co, Ni or Mn, possibly with metallic dopings such as but limited to Al, Ti, Mg, Zn, Cr, and the like.

Furthermore, the cell housing 1 contains an organic liquid electrolyte with a conductive salt containing lithium (LiPF₆, LiCIO₄, LiBF₄ or the like), a solid electrolyte (for example, zeolite), or a polymer electrolyte (for example PEO, PVDF, PAN). Possibly, it may also contain a separator 4 (for example, composed of PP, PE, PTFE, PVDF and the like) and a negative indium electrode 3, which is inserted as a sheet or, as illustrated in FIG. 1, as a powder. The powder can be mixed with normal binding agents (PVDF, PTFE and the like) and with conductive carbon black. The negative indium electrode may also be located on an output conductor mesh 6. The negative electrode, which is introduced into the cell housing, contains a high percentage of indium, for example, more than about 70%, preferably at least about 90%, and particularly advantageously at least about 99% of indium.

The lithium rechargeable battery produced in this way has an uncharged positive electrode 5 and a negative indium electrode 3. In comparison to a conventional negative graphite electrode, this indium electrode has a higher specific capacity (graphite: 372 mAh/g), which may be up to a specific capacity that is three times higher. Considerably higher energy densities are thus possible in a lithium-ion rechargeable battery such as this.

Furthermore, a lithium rechargeable battery with a negative electrode having a high indium component can be produced considerably more easily. The indium electrode 3 may be introduced into the cell housing as a thin sheet or as a powder, possibly with normal binding agents such as PTFE or PVDF. There is no need for a complex anode recipe or synthesis, as in the case of alloy electrodes.

### EXAMPLE

To produce a button cell according to aspects of the invention (dimensions: diameter: 20 mm; height: 2.5 mm), a 100 μm thick indium sheet with a diameter of 16 mm is pressed as the negative electrode at normal atmospheric pressure into an output conductor mesh composed of a stainless steel mesh in a button cell cover. In this case, the indium may also be in powder form mixed with a conductive material such as MCMB (Mesocarbon Microbeads) and may be in tablet form, or may be coated onto an appropriate output conductor mesh and introduced into the cell as a coated sheet. The capacity of the negative electrode, calculated from the dimensions, is about 500 mAh/g.

A PP separator is then placed on the indium, for example, Celgard2500®, and a non-woven, for example, KodoshiP334®.

A solvent mixture composed of cyclic carbonate (for example, ethylene carbonate) and open-chain carbonate (for example, diethyl carbonate) with a mixture ratio of about 1:1 to about 2:8 may be used for the electrolyte, depending on the application. Lithiumhexafluorophosphate is dissolved in the electrolyte as a conductive salt.

LiCoO₂ with the normal binding agents (PVDF, PTFE) and conductive carbon black mixed with it and coated onto an aluminium output conductor mesh (90% LiCoO₂, 4% carbon black, 6% binding agent) is used for the positive electrode. The positive electrode is stamped out in tablet form (about 400-about 600 mg) and, having been impregnated with electrolyte, is inserted into the cell container of the cell housing. The cover and the container are joined together, and the cell is closed. The completed cell is then charged at up to 4.2 V with 1 C. In this case, 1 C means, explained using an example, that 1 C corresponds to 0.5 A if the cell capacity is 0.5 Ah. This value is a so-called “empirical” value, which is not defined scientifically, but is frequently used in practice.

The lithium/indium alloy is formed in this formation or charging step. The lithium in the positive electrode migrates in the process to the negative electrode, and forms a coating or alloy on the indium.

Formation of the lithium/indium alloy during the formation process:
Li_{(A+B)}CoO₂+Inₙ [symbol] Li_{(A)}CoO₂+Li_{(B)}Inₙ

This formulation allows a battery to be produced which achieves 150 cycles for a depth of discharge (DOD) of 100%, and 850 cycles for a depth of discharge of 20%, with considerably higher energy densities than with graphite electrodes.

1. A method for production of a rechargeable electrochemical element having a negative electrode composed of a lithium/indium alloy, and having a positive, lithium-intercalating electrode in a housing, wherein the negative electrode, which is composed predominantly of indium, an uncharged positive electrode with an active compound containing lithium, and an electrolyte are introduced into the housing, and a negative lithium/indium electrode is formed by subsequent formation of the element.

2. The method according to claim 1, wherein at least about 70 percent of the negative electrode is indium.

3. The method according to claim 1, wherein at least about 95 percent of the negative electrode is indium.

4. The method according to claim 1, wherein the positive electrode, with the active compound containing lithium, has an element M selected from the following group:
Ni, Co, Mn,
where the compound with the element M is used in the form LiMOₓ.

5. The method according to claim 4, wherein the LiMOₓ compound is doped with at least one of the metals selected from the following group:
Al, Ti, Mg, Zn, Cr.

6. A rechargeable electrochemical element having a negative electrode composed of a lithium/indium alloy, and having a positive lithium-intercalating electrode in a housing according to claim 1.

7. A method of producing a rechargeable electrochemical element comprising:
introducing a negative electrode composed mainly of indium, an uncharged positive electrode having an active compound containing lithium, and an electrolyte into a housing; and
applying a charge to form a negative lithium/indium electrode in the element.

8. The method according to claim 7, wherein at least about 70 percent of the negative electrode is indium.

9. The method according to claim 7, wherein at least about 95 percent of the negative electrode is indium.

10. The method according to claim 7, wherein the positive electrode contains at least one element M selected from the group consisting of Ni, Co and Mn, and wherein element M is in a compound in the form LiMOₓ.

11. The method according to claim 10, wherein the LiMOₓ compound is doped with at least one metal selected from the group consisting of Al, Ti, Mg, Zn and Cr.

12. A rechargeable electrochemical element produced according to claim 1.

13. A method of producing a rechargeable electrochemical element comprising:
introducing a negative electrode composed mainly of indium, an uncharged positive electrode having an active compound containing lithium, and an electrolyte into a housing; and
causing lithium in the positive electrode to migrate to the negative by applying a charge to form a negative lithium/indium electrode.

14. The method according to claim 13, wherein at least about 70 percent of the negative electrode is indium.

15. The method according to claim 13, wherein at least about 95 percent of the negative electrode is indium.

16. The method according to claim 13, wherein the positive electrode contains at least one element M selected from the group consisting of Ni, Co and Mn, and wherein element M is in a compound in the form LiMOₓ.

17. The method according to claim 16, wherein the LiMOₓ compound is doped with at least one metal selected from the group consisting of Al, Ti, Mg, Zn and Cr.

18. The method according to claim 13, wherein the migrating lithium forms a coating or an alloy on the indium.

19. A rechargeable electrochemical element produced according to claim 13.
